(19) United States
(12) Patent Application Publication
(10) Pub. No.: US 2006/0193614 A1
(43) Pub. Date: Aug. 31, 2006

(54) Waterproof housing

(75) Inventors: Shinichi Watanabe, Tokyo (JP); Koji Funahashi, Tokyo (JP)

Correspondence Address: VOLPE AND KOENIG, P.C., UNITED PLAZA, SUITE 1600, 30 SOUTH 17TH STREET, PHILADELPHIA, PA, 19103, US

(73) Assignee: Olympus Imaging Corp., Tokyo (JP)

(21) Appl. No.: 11/344,617

(22) Filed: Feb. 1, 2006

(30) Foreign Application Priority Data
Feb. 28, 2005 (JP) 2005-055108

(51) Int. Cl. G03B 17/08

(52) U.S. Cl. 396/27

(57) ABSTRACT

In a waterproof housing for storing a camera, a transparent window for causing light to be refracted toward a nearer side is provided on at least part of a portion that covers a front surface of the camera. Accordingly, a direction of travel of light from the camera is bent toward an optical axis of a photographic lens, and hence a photographic subject can easily get light. The light is, for example, auxiliary light used for automatic focusing.

### CROSS-REFERENCE TO RELATED APPLICATION

This application is based upon and claims the benefit of priority from prior Japanese Patent Application No.2005-055108, filed on Feb. 28, 2005, the entire contents of which are incorporated herein by reference.

### BACKGROUND OF THE INVENTION

1. Field of the Invention

The present invention relates to a waterproof housing (waterproof protector, waterproof case) for storing a camera such as a film camera, a digital camera, a video camera and operating the stored camera from an outside the housing. The invention specifically relates to a waterproof housing suitable for storing a camera having an automatic focusing device.

2. Description of the Related Art

A waterproof housing (waterproof protector, waterproof case) for fitting and storing a camera therein for performing underwater photography is known. In general, a waterproof housing is formed of light-transmitting synthetic resin so that a state of an interior thereof can be observed.

As shown in FIG. 3, a unit of camera having an automatic focusing device (AF camera) projects auxiliary light (AF auxiliary light) for automatic focusing from a light-emitting element 22 provided on a front surface of a camera 20, measures a distance using reflected light from a photographic subject, drives an AF lens, and performs the focusing. The auxiliary light from the light-emitting element 22 is projected toward a nearer side (a side of an optical axis) so as to be irradiated on and reflected from the photographic subject. For example, an angle of light-emission of the auxiliary light is set so that a light path L1 of the auxiliary light intersects with an optical axis O at a point X, which is 6 meters ahead thereof.

On the other hand, a wall (housing wall) 112a of a waterproof housing 110 is formed to have a thickness with a water pressure taken into consideration. A front surface of the waterproof housing 110 is formed into a curved shape rounded to project toward the front because a lens of the camera is to be stored therein. Therefore, the housing wall 112a formed of synthetic resin serves as a convex lens. Therefore, when the camera 20 having the automatic focusing device is stored in the waterproof housing 110, a light path L2 of the auxiliary light from the light-emitting element is refracted to a direction apart from the optical axis O by the housing wall 112a that faces the light-emitting element 22 provided on the front surface of the camera. Therefore, there is a possibility that the auxiliary light can hardly reach the photographic subject.

For example, in a case in which the camera 20 with the automatic focusing device is of a type that measures the distance and takes the focus using contrast of the photographic subject, if the auxiliary light can hardly reach the photographic subject and hence an amount of reflected light is small (when a brightness of the photographic subject is low), the contrast becomes unclear, and focusing becomes difficult. In particular, in a case of underwater photography, since a light amount is originally smaller than normal photography ashore and hence the brightness of the photographic subject is low, there is a tendency that measurement of the distance and focusing are difficult. There is a case in which focusing cannot be achieved in the underwater photography even when focusing can be achieved at the same distance in the photography ashore.

A camera which can take focus even when measurement of the distance using the auxiliary light is difficult is known. For example, in a case of a camera disclosed in JP-A-06-222258, when measurement of the distance using the auxiliary light is difficult, focusing is enabled by issuing a predetermined signal, emitting flash light, fixing a lens at a fixed focal point, and narrowing an aperture for photographing.

However, with a structure disclosed in JP-A-06-222258, focusing of the photographic subject in the underwater photography is enabled only when the camera that employs the structure described above is stored in the waterproof housing. A camera in which hindrance due to refraction of the auxiliary light is solved from a viewpoint of the waterproof housing is not known.

### BRIEF SUMMARY OF THE INVENTION

A waterproof housing of the invention can store a camera, and at least part of a portion that covers a front surface of the camera is a transparent area. The area partly includes an optically functioning surface that causes light emitted from the camera to be refracted toward a nearer side.

With this optically functioning surface, light emitted from the camera in a state of being stored in the waterproof housing is refracted to the nearer side in comparison with light emitted from the camera in a state of not being stored in the waterproof housing.

Therefore, a photographic subject can easily get the light.

The optically functioning surface can be configured to have a flat inclined surface on an inner surface of the waterproof housing. In this case, light incoming straightly is refracted by the inclined surface.

The light described above is, for example, auxiliary light emitted from the camera for automatic focusing.

The optically functioning surface described above may be at least part of a prism. For example, when the optically functioning surface (transmitted light incoming surface) is configured to be a plane inclined with respect to an axis of transmitted light, the prism is formed with a transmitted light outgoing surface on an outside of the waterproof housing.

A housing member may be formed of a transparent synthetic resin material.

The phrase “to cause light to be refracted to the nearer side” includes “to cause the transmitted light to be refracted in a direction toward an optical axis of an image pickup lens of the camera”.

According to the invention, a direction of projection of the auxiliary light from the camera is forcedly refracted to the nearer side by a light-projecting window (or an optical plane). Therefore, projection of the auxiliary light onto the photographic subject is enabled, and hence measurement of the distance and focusing of the photographic subject in the nearer side can be achieved using the auxiliary light.

The term “transparent” in this specification means that light can pass through at least partly without scattering, and does not necessarily mean that 100 percent of light can be transmitted.

### BRIEF DESCRIPTION OF THE SEVERAL VIEWS OF THE DRAWINGS

These and other features, aspects, and advantages of the apparatus and methods of the invention will become better understood with regard to the following description, appended claims, and accompanying drawings where:

FIG. 1 is a schematic cross-sectional view of a waterproof housing according to a first embodiment of the invention;

FIG. 2 is an exploded internal view of the waterproof housing when viewed in a direction indicated by an arrow A in FIG. 1; and

FIG. 3 is a schematic cross-sectional view of a waterproof housing in the related art.

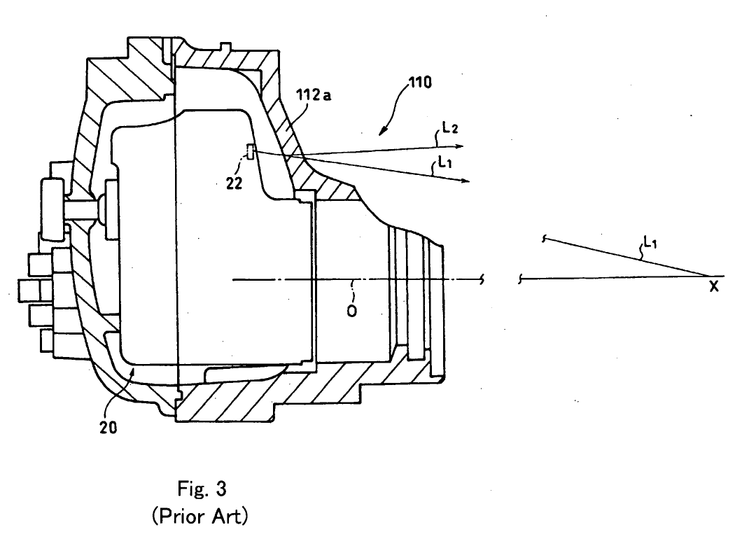

### DETAILED DESCRIPTION OF THE PREFERRED EMBODIMENTS

A preferred embodiment of the invention is described below with reference to the accompanying drawings.

In the invention, a direction of projection of auxiliary light from a camera is forcedly refracted toward a nearer side by providing a light-projecting window on a waterproof housing.

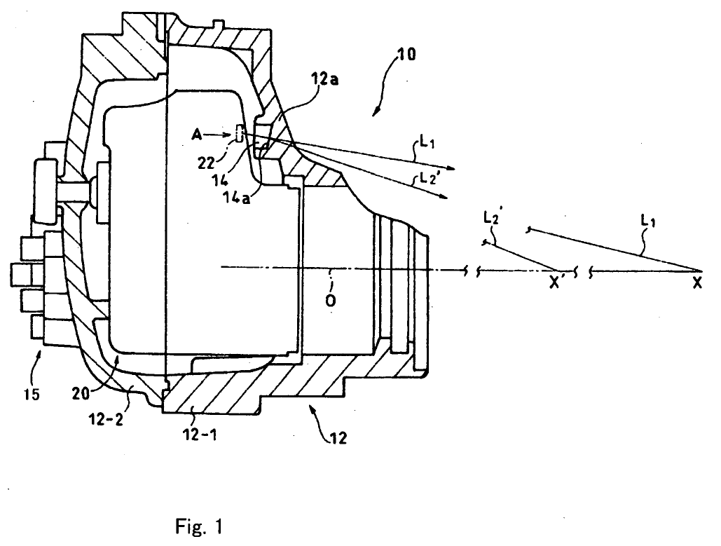

FIG. 1 is a schematic cross-sectional view of a waterproof housing 10 according to a first embodiment of the invention. For simplicity of the drawing, it shows a vertical cross-section including an optical axis of a photographic lens as a whole, and part of the cross-section includes a light-emitting element described later instead of the optical axis of the photographic lens.

The waterproof housing 10 includes a housing body 12 for storing a camera, for example, such as a digital camera. In the embodiment, a camera (AF camera) 20 having an automatic focusing device is stored in the housing body 12, and a light-emitting element 22 for projecting auxiliary light (AF auxiliary light) for automatic focusing is provided on a front surface of the camera. The camera 20 is shown only by a contour thereof for avoiding complexity of the drawing.

A basic structure of the hosing body 12 is the same as in the related art. The housing body 12 includes a main body portion 12-1 and a back lid portion 12-2 formed respectively of synthetic resin having a thickness that can resist a water pressure and joined to each other with a hinge. Various switch operating members 15 for operating switches of the camera 20 from an outside of the camera are provided on the main body portion 12-1 and the back lid portion 12-2 as needed. The main body portion 12-1 and the back lid portion 12-2 of the housing body 12 are formed of synthetic resin which transmits light so that the camera 20 stored therein can be viewed from the outside.

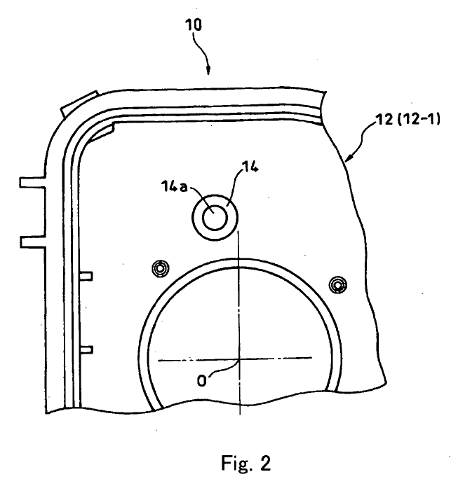

FIG. 2 is an exploded internal view of the main body portion 12-1 of the housing body 12 viewed in a direction indicated by an arrow A in FIG. 1. As shown in FIG. 1 and FIG. 2, a housing wall 12a that faces the light-emitting element 22 on the front surface of the camera is formed with a light-projecting window 14 that transmits the auxiliary light from the light emitting element 22. The light-projecting window 14 is formed into, for example, a circular hole having a window surface which serves as an optical plane 14a and, as shown in FIG. 1, the optical plane 14a is a flat inclined surface (flat bevel) inclined at an upper end thereof toward a photographic subject. Therefore, the optical plane 14a and an outer surface, which is the housing wall 12a, function as a prism. The shape formed by the optical plane 14a and the outer surface is not limited to a prism, and may be any shape as long as it causes the auxiliary light (emitted light, projected light) to be refracted. Since it is not necessary to be a prism shape as long as it has only to have an optical function which is the same as the optical function for causing light to be refracted, for example, it may be a lens having a light converging function and causing light to be refracted.

The light-projecting window 14 includes the optical plane 14a on its window surface, and is formed on the housing wall 12a so as to oppose the light-emitting element 22. Since the optical plane 14a is the flat inclined surface (flat bevel) having the upper end thereof inclined toward the photographic subject, the auxiliary light projected from the light-emitting element is forcedly refracted to the nearer side (a side of the optical axis) by the light-projecting window 14 in comparison with a case in which the light is emitted from the camera without the housing. For example, an angle of inclination of the optical plane 14a of the light-projecting window 14 is set so that a light path L2′ of the auxiliary light intersects with an optical axis O at a point X′ which is a point 60 cm ahead. A light path L1 indicates a light path of the auxiliary light when the camera 20 is not stored in the waterproof housing 10, and intersects with the optical axis O at a point X, which is a point 6 meter ahead.

In this manner, the auxiliary light (AF auxiliary light) from the light-emitting element 22 of the camera (AF camera) 20 is forcedly refracted toward the nearer side by the light-projecting window 14 on the housing wall 12a. Therefore, even when the housing wall formed of synthetic resin serves as a convex lens, the auxiliary light is reliably projected on the photographic subject on the nearer side. Therefore, even in underwater photography with less amount of light, measurement of the distance using reflected light of the auxiliary light is enabled, whereby focusing with respect to the photographic subject on the nearer side is enabled.

According to the invention, adverse effects of the housing wall 12a can be eliminated with a simple structure such that the light-projecting window 14 which forcedly causes the auxiliary light from the light-emitting element 22 of the camera 20 to be refracted toward the nearer side is provided on the housing wall 12a.

Focusing of the photographic subject on the nearer side is achieved irrespective of the type of the camera stored in the waterproof housing 10 in the underwater photography, and hence the camera that can be stored therein is not limited.

The optical plane 14a must simply be the one which forcedly causes the auxiliary light from the light-emitting element 22 of the camera 20 to be refracted toward the nearer side, and is not limited to the flat inclined surface (flat bevel) as shown in the embodiment. However, when the flat bevel is employed, projection on the photographic subject on the nearer side can be achieved reliably without causing the auxiliary light to scatter.

According to the invention, the waterproof housing can be used commonly for any types of cameras as long as they can be stored therein, and can be applied in a wide range.

While there has been shown and described what are considered to be a preferred embodiment of the invention, it will, of course, be understood that various modifications and changes in form or detail could readily be made without departing from the spirit of the invention. It is therefore intended that the invention not be limited to the exact forms described and illustrated, but constructed to cover all modifications that may fall within the scope of the appended claims.

What is claimed is:

1. A waterproof housing for a camera comprising:
the waterproof housing that can store the camera and at least part of an area of the waterproof housing that covers a front surface of the camera is transparent; and
a transparent window provided in the part of the area, the transparent window includes an optically functioning surface that enables light emitted from the camera stored in the waterproof housing to be refracted to a nearer side in comparison with light emitted from the camera not being stored in the waterproof housing.

2. The waterproof housing for a camera according to claim 1, wherein the optically functioning surface includes a flat inclined surface provided on an inner surface of the waterproof housing.

3. The waterproof housing for a camera according to claim 1, wherein the transparent window allows transmission of auxiliary light for automatic focusing emitted from the camera.

4. The waterproof housing for a camera according to claim 1, wherein the optically functioning surface constitutes at least part of a prism.

5. A waterproof housing for a camera comprising:
the waterproof housing that can store the camera therein; and
a light-projecting window for transmitting light emitted from the camera, wherein the light-projecting window includes an optically functioning surface that enables light emitted form the camera when the camera is stored in the waterproof housing to be refracted toward a nearer side in comparison with light emitted from the camera when the camera is not stored in the waterproof housing.

6. The waterproof housing for a camera according to claim 5, wherein a housing member of the waterproof housing having the light-projecting window is formed of a transparent synthetic resin material.

7. The waterproof housing for a camera according to claim 5, wherein the optically functioning surface includes a flat inclined surface on an inner surface of the waterproof housing.

8. The waterproof housing for a camera according to claim 5, wherein the light-projecting window allows transmission of auxiliary light for automatic focusing emitted from the camera.

9. The waterproof housing for a camera according to claim 5, wherein the optically functioning surface constitutes a prism.

10. A waterproof housing for a camera comprising:
an area that transmits light emitted from the camera, wherein the area refracts the light emitted from the camera so that the transmitted light approaches more steeply to an optical axis of a photographic lens of the camera.
